(19) United States
(12) Patent Application Publication
(10) Pub. No.: US 2009/0237321 A1
(43) Pub. Date: Sep. 24, 2009

(54) MULTI-ANTENNA MODULE HAVING SPECIFIC DISPOSAL

(76) Inventors: Hsiao-Kuang Lin, Taipei (TW); Kuo-Ping Lee, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/262,183

(22) Filed: Oct. 31, 2008

(30) Foreign Application Priority Data
Mar. 24, 2008 (TW) 097110384

(51) Int. Cl. H01Q 21/00

(52) U.S. Cl. 343/893

(57) ABSTRACT

A multi-antenna module includes a plurality of antennas for receiving or transmitting a plurality of wireless signals. When one of the antennas is utilized to receive a satellite signal, a position of the antenna is disposed higher than those of the other antennas in the multi-antenna module; when one of the antennas is utilized to receive or transmit a WPAN or WLAN signal, the antenna is disposed on one side of the multi-antenna module; and when one of the antennas is utilized to receive or transmit a WMAN or WWAN signal, a position of the antenna is disposed lower than those of the other antennas in the multi-antenna module. Through planning the disposition of the antennas and the distance between two antennas, the present invention can reduce signal interference problems and achieve better signal isolation, thereby effectively integrating functions of various wireless communication systems into the multi-antenna module.

### BACKGROUND OF THE INVENTION

1. Field of the Invention

The present invention relates to a multi-antenna module, and more particularly, to a multi-antenna module with specific disposal of antennas for achieving better signal isolation.

2. Description of the Prior Art

Nowadays, many manufacturers are actively trying to integrate functions of various communication systems such as a Global Positioning System (GPS) and a Global System for Mobile communication (GSM) into a wireless communication apparatus, to improve the efficiency of the wireless communication apparatus and enhance functions/applications thereof. In such an application, the wireless communication apparatus is arranged to transmit and receive various wireless communication signals corresponding to different communication systems. Many of the different communication systems are arranged to employ similar frequency bands due to the limited number of open frequency bands. Thus, signal interference caused by a communication signal that affects reception of another communication signal is a common occurrence, and the communication quality is thereby decreased.

A conventional solution such as a micro-strip antenna disclosed by U.S. Pat. No. 6,225,950, adopts a polarization separation scheme to improve the signal isolation between two antennas in order to reduce signal interference problems. In the micro-strip antenna, two radiation elements with the same properties are disposed in the vertical direction such that the radiation patterns thereof can be mutually orthogonal. The micro-strip antenna, however, is limited by the fact that the radiation elements have to possess absolutely identical properties such as size and bandwidth. Thus, a general manufacturer has to give an order to an antenna manufacturer for specifically produced radiation elements and cannot apply ready-made radiation elements to his/her products. Therefore, the practicability of the micro-strip antenna is lessened.

Additionally, U.S. Publication No. 2007/0069960 discloses a flat-plate antenna in which an isolation element connected to ground is interposed between two antenna elements. However, the flat-plate antenna is not suitable for implementation of antenna elements employed by different wireless communication systems. This is because the properties and manufacture processes of the antenna elements employed by different wireless communication systems are also different. For example, circular polarization antenna elements employed by the GPS system are usually ceramics antenna elements, and it is not easy to implement the ceramics antenna elements and printed circuit board (PCB) antenna elements on the same plane. In addition, the fabrication is limited to the same plane, so the flat-plane antenna is not suitable for use in an embedded system or on PCBs/apparatuses of electronics products that have the requirements of being lightweight, thin, short, and small.

### SUMMARY OF THE INVENTION

In view of this, an objective of the present invention is to provide a multi-antenna module and related rules for configuration of each antenna in the multi-antenna module.

By way of planning the distance between any two antennas and a related configuration, the multi-antenna module provided by the present invention can achieve better signal isolation and efficiently integrate functions of various wireless communication modules into the multi-antenna module itself. Compared to the conventional scheme, the multi-antenna module provided by the present invention can directly employ ready-made antennas or antennas produced under different process conditions. Furthermore, the multi-antenna module provided by the present invention is not limited to a planar assembly device, so it not only has flexibility to apply the multi-antenna module to other applications but also speeds up product development due to fewer limitations in the product development process.

According to an embodiment of the claimed invention, a multi-antenna module is disclosed. The multi-antenna module comprises a first antenna for receiving or transmitting a first wireless signal, a second antenna for receiving or transmitting a second wireless signal, and a third antenna for receiving or transmitting a third wireless signal. The first wireless signal comprises at least one of a satellite signal, a WMAN/WWAN signal, and a WPAN/WLAN signal. Either of the second and third wireless signals comprises at least one of a WMAN/WWAN signal, a WPAN/WLAN signal, and a UWB signal. A position of the first antenna is disposed higher than those of the other antennas in the multi-antenna module when the first wireless signal comprises a satellite signal. The second antenna is disposed on one side of the multi-antenna module when the second wireless signal comprises a WPAN/WLAN signal. A position of the third antenna is disposed lower than those of the other antennas in the multi-antenna module when the third wireless signal comprises a WMAN/WWAN signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multi-antenna module according to an embodiment of the present invention.

FIG. 2 is a diagram illustrating an embodiment of the multi-antenna module of FIG. 1 applied to integrating functions of the GPS and WPAN/WLAN systems into the multi-antenna module.

FIG. 3 is a diagram illustrating an embodiment of the multi-antenna module of FIG. 1 applied to integrating functions of the WPAN/WLAN and WMAN/WWAN systems into the multi-antenna module.

FIG. 4 is a diagram of a multi-antenna module according to another embodiment of the present invention.

FIG. 5 is a diagram illustrating an embodiment of the multi-antenna module of FIG. 4 applied to integrating functions of the GPS, WLAN, WPAN, and WWAN systems into the multi-antenna module.

FIG. 6 is a diagram illustrating an embodiment of the multi-antenna module of FIG. 4 applied to integrating functions of the GPS, UWB, WLAN and BT, and WWAN systems into the multi-antenna module.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The rules for configuration of antenna(s), which are provided by the following embodiments of the present invention, are detailed in the following description. When an antenna is utilized for receiving a satellite signal such as a global positioning system (GPS) signal or a satellite radio signal, a position of the antenna is disposed higher than those of the other antennas in a multi-antenna module in order to receive the satellite signal sent from a satellite completely. When the antenna is utilized for receiving/transmitting a wireless metropolitan area network (WMAN) signal such as the Worldwide Interoperability for Microwave Access (WiMAX) signal specified by the communication standard 802.16 or for receiving/transmitting a wireless wide area network (WWAN) signal such as a third-generation mobile system (3G) signal, a Wideband Code Division Multiple Access (WCDMA) signal, a General Packet Radio Service (GPRS) signal, or an Enhanced Data rates for GSM Evolution (EDGE) signal, a position of the antenna is disposed lower than those of the other antennas in the multi-antenna module, to prevent the WMAN/WWAN signal with high power from jamming the relatively feeble satellite signal that is degraded by the Heaviside layer of the Earth and distance the range of the antenna with high power away from the human brain to decrease the specific absorption rate (SAR) of the multi-antenna module. In addition, when an antenna is utilized for receiving/transmitting a WPAN signal such as a Bluetooth (BT) signal, a Zigbee signal, or a radio-frequency identification (RFID) signal or for receiving/transmitting a WLAN signal such as a WiFi signal specified by the communication standard IEEE 802.11, the antenna is disposed on the left/right side of the multi-antenna module so as to achieve the aim of the distance between any two antennas being as long as possible.

In addition, according to electromagnetic wave theory, when a distance between two antennas is half a wavelength of an electromagnetic wave or odd integer multiples of half the wavelength, a phase difference between electromagnetic waves radiated from the two antennas is exactly 180 degrees and the effect of mutual coupling between the two antennas is minimized; the effect is as if there is an electric wall separating the two antennas. Accordingly, the multi-antenna module in the embodiments of the present invention provides specific disposal for an appropriate distance between any two antennas, which arranges that a distance between the two antennas corresponding to different wireless systems is equal to or longer than half a wavelength of an interfered signal in two wireless signals, so as to reduce the signal interference problems. In an embodiment, if the size of the multi-antenna module is big enough, the distance between the two antennas can be designed to be odd integer multiples of half the wavelength, so as to enhance the signal isolation for the wireless signals. In the following, embodiments of multi-antenna modules respectively including three antennas and four antennas are provided for illustration.

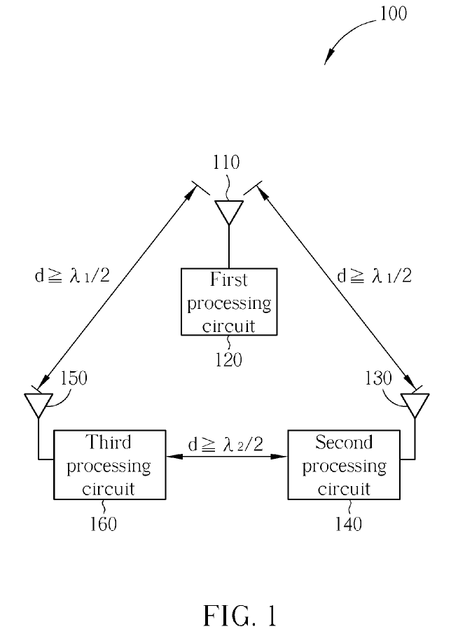

The multi-antenna module of the embodiments of the present invention can be applied to an embedded system to provide a combination of functions of various wireless communication systems. The embedded system can be (but is not limited to) a communication device such as a notebook/laptop, a personal computer, a navigation satellite system, a mother board, a server, and so on. FIG. 1 is a diagram of a multi-antenna module according to an embodiment of the present invention. In this embodiment, the multi-antenna module 100 comprises a first antenna 110 for receiving/transmitting a first wireless signal, a first processing circuit 120 coupled to the first antenna 110 and used for processing the first wireless signal, a second antenna 130 for receiving/transmitting a second wireless signal, a second processing circuit 140 coupled to the second antenna 130 and used for processing the second wireless signal, a third antenna 150 for receiving/transmitting a third wireless signal, and a third processing circuit 160 coupled to the third antenna 150 and used for processing the third wireless signal. The distance between the first antenna 110 and the second antenna 130 is longer than or equal to half a wavelength of the first wireless signal, i.e.

$$\frac{{λ}_{1}}{2} .$$

If the size of the multi-antenna module 100 is big enough, the distance between the first antenna 110 and the second antenna 130 can be odd integer multiples of half the wavelength of the first wireless signal, so as to improve signal isolation. In addition, the distance between the first antenna 110 and the third antenna 150 is longer than or equal to half the wavelength of the first wireless signal, i.e.

$$\frac{{λ}_{1}}{2} .$$

If the size of the multi-antenna module 100 is big enough, the distance between the first antenna 110 and the third antenna 150 can be odd integer multiples of half the wavelength of the first wireless signal, so as to improve signal isolation. Similarly, the distance between the second antenna 130 and the third antenna 150 is longer than or equal to half a wavelength of the second wireless signal, i.e.

$$\frac{{λ}_{2}}{2} .$$

If the size of the multi-antenna module 100 is big enough, the distance between the second antenna 130 and the third antenna 150 can be odd integer multiples of half the wavelength of the second wireless signal, so as to improve signal isolation. In this embodiment, it is assumed that the first antenna 110 is interfered with by the second wireless signal and third wireless signal when receiving the first wireless signal, and the second antenna 130 is interfered with by the third wireless signal when receiving the second wireless signal.

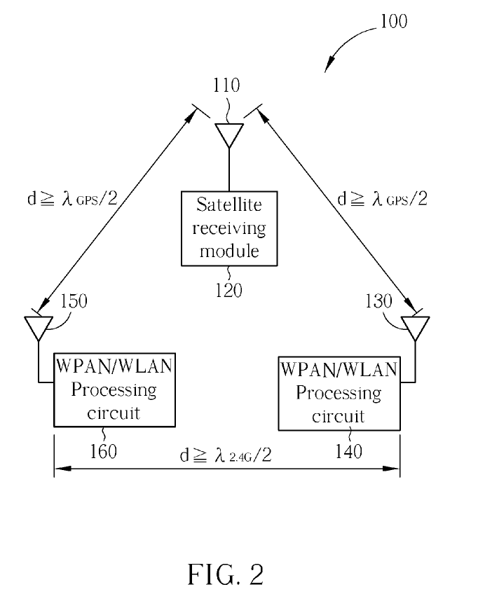

The first wireless signal comprises a satellite signal, a WPAN signal, a WLAN signal, a WMAN signal, a WWAN signal, or any combination of the above-mentioned wireless signals. The second/third wireless signal comprises a WPAN signal, a WLAN signal, a WMAN signal, a WWAN signal, an Ultra Wide Band (UWB) signal, or any combination of the above-described wireless signals. Please refer to FIG. 2, which illustrates an embodiment of the multi-antenna module 100 shown in FIG. 1. As shown in FIG. 2, the first antenna 110 is utilized for receiving a GPS signal and the position of the first antenna 110 is disposed higher than those of the other antennas in the multi-antenna module 100; for example, the first antenna 110 is disposed at the top of the multi-antenna module 100 to completely receive signals from satellite(s). The second antenna 130 and the third antenna 150 respectively correspond to a WPAN signal and a WLAN signal or to a WLAN signal and a WPAN signal. The second antenna 130 and the third antenna 150 are set up on different sides at the bottom of the multi-antenna module 100. In this embodiment, the antennas 110, 130, and 150 are arranged in the form of an equilateral triangle, so as to make the distance between each antenna be as great as possible for improving the signal isolation.

Additionally, the distance between the first antenna 110 and the second antenna 130 can be equal to or longer than half a wavelength of the GPS signal, and the distance between the first antenna 110 and the third antenna 150 can be equal to or longer than half the wavelength of the GPS signal. That is, the first antenna 110 is at a distance from the second and third antennas 130, 150 of half the wavelength of the GPS signal at least, i.e. the distance λ_{GPS}/2 (or about 9.52 cm). If the size of the multi-antenna module 100 is big enough, the first antenna 110 can be at a distance from the second and third antennas 130, 150 of odd integer multiples of half the wavelength of the GPS signal, i.e. the distance of odd integer multiples of 9.52 cm. Since the first antenna 110 is used for receiving the GPS signal without transmitting, reception of the WPAN/WLAN signal is not interfered with by the GPS signal when the antennas 110, 130, and 150 are installed within a system or a chip. The GPS signal, however, may be interfered with by the WPAN/WLAN signal when the WPAN/WLAN signal is transmitted from either of the second and third antennas 130 and 150. That is to say, noise may be introduced to the GPS band due to the transmitted WPAN/WLAN signal. The GPS signal herein is an interfered signal. Therefore, the first antenna 110 is disposed to be at a distance from the second and third antennas 130 and 150 of at least λ_{GPS}/2 to achieve better signal isolation, for minimizing the noise occurring at the GPS band due to the transmitted WPAN/WLAN signal. Because the WPAN/WLAN signal is transmitted or received at the 2.4 GHz band, the second antenna 130 is at a distance from the third antenna 150 of at least half a wavelength at the 2.4 GHz band, i.e. the distance of λ_{2.4G}/2 (or about 6.12 cm) at least. If the size of the multi-antenna module 100 is big enough, the second antenna 130 can be at a distance from the third antenna 150 of odd integer multiples of 6.12 cm to achieve better signal isolation, for decreasing noise resulting from mutual signal interference between the second antenna 130 and the third antenna 150.

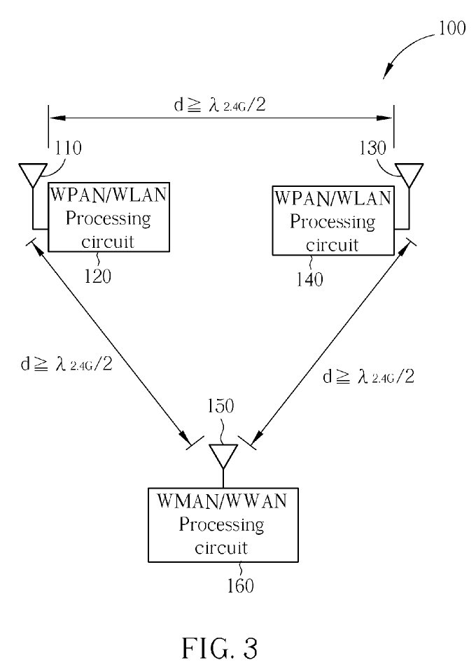

Please refer to FIG. 3, which illustrates an embodiment of the multi-antenna module 100 having an antenna 150 for receiving and transmitting a WMAN/WWAN signal. In this embodiment, the third antenna 150 is utilized for receiving and transmitting the WMAN/WWAN signal, and a position of the third antenna 150 is disposed lower than those of the other antennas (i.e. 110 and 130) in the multi-antenna module 100. For instance, the third antenna 150 can be disposed at the bottom of the multi-antenna module 100 such that the multi-antenna module 100 conforms to the SAR specification. The first antenna 110 and the second antenna 130, which are used for respectively receiving and transmitting the WPAN/WLAN signal, are set up on different sides of the multi-antenna module 100 above the bottom of the multi-antenna module 100, for making the distance between each antenna be as great as possible for decreasing noise resulting from mutual interference between each antenna. Since the WMAN/WWAN signal is a signal with high power, the third antenna 150 is at a distance from the first antenna 110 and the second antenna 130 of at least λ_{2.4G}/2, respectively, for better signal isolation to prevent the WMAN/WWAN signal from interfering with reception of the WPAN/WLAN signal.

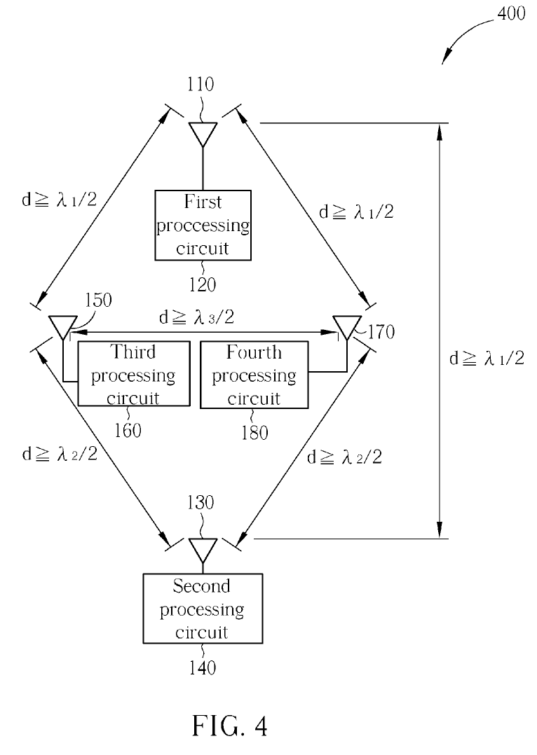

When a multi-antenna module comprises a fourth antenna, the antennas of the multi-antenna module can be disposed in a manner as shown in FIG. 4. In order to prevent a fourth wireless signal from interfering with reception/demodulation of the first, second, and third wireless signals, the first antenna 110 is arranged to be at a distance from the fourth antenna 170 of half

the wavelength of the first wireless signal at least, i.e. the distance

$$\frac{{λ}_{1}}{2}$$

at least; the second antenna 130 is arranged to be at a distance from the fourth antenna 170 of half the wavelength of the second wireless signal at least, i.e. the distance

$$\frac{{λ}_{2}}{2}$$

at least, and the third antenna 150 is arranged to be at a distance from the fourth antenna 170 of half the wavelength of the third wireless signal at least, i.e. the distance

$$\frac{{λ}_{3}}{2}$$

at least. Similarly, if the size of the multi-antenna module 400 is available, the distance between the first antenna 110 and the fourth antenna 170 can be odd integer multiples of half the wavelength of the first wireless signal, and the distance between the second antenna 130 and the fourth antenna 170 can be odd integer multiples of half the wavelength of the second wireless signal; the distance between the third antenna 150 and the fourth antenna 170 can be odd integer multiples of half the wavelength of the third wireless signal. This can improve the signal isolation further.

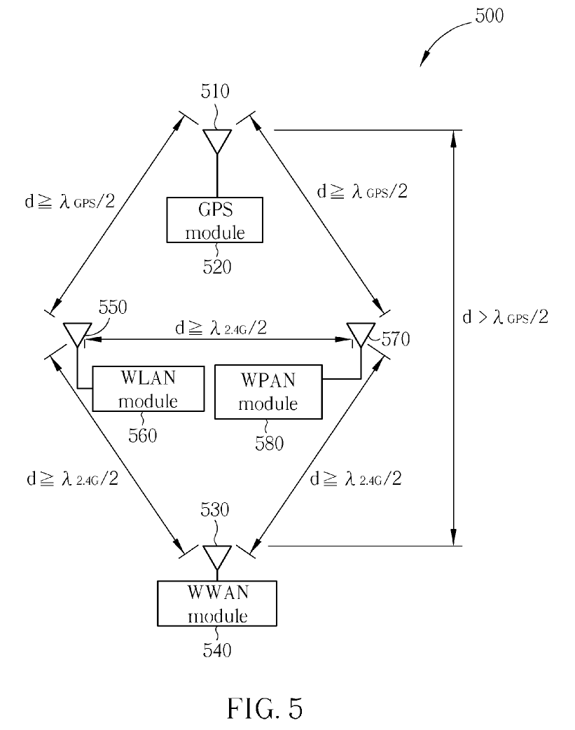

In an embodiment, the third and fourth wireless signals are WLAN signals, WPAN signals, WWAN signals, WMAN signals, UWB signals, or any combination of the above-mentioned signals. Please refer to FIG. 5, which illustrates an embodiment of the multi-antenna module shown in FIG. 4 applied to integrating functions of the GPS, WLAN, WPAN, and the WWNA systems into the multi-antenna module 500 itself. As shown in FIG. 5, the position of the GPS antenna 510 is disposed higher than those of the other antennas in the multi-antenna module 500; for instance, the GPS antenna 510 can be set up at the top of the multi-antenna module 500, and it is beneficial for the GPS antenna 510 to receive satellite signals. The WWAN antenna 530 for transmitting and receiving the WWAN signal with high power is set up at the bottom, so the position of the WWAN antenna 530 is lower than those of the other antennas in the multi-antenna module 500. In addition, the WWAN antenna 530 is arranged to be far away from the GPS antenna 510, in order to prevent the WWAN signal from interfering with the GPS signal and decrease the SAR of the multi-antenna module 500. Furthermore, the WLAN antenna 550 and the WPAN antenna 570 can be disposed on different sides of the multi-antenna module 500, e.g. respectively on the left and right sides, such that these four antennas can be arranged in the form of a rhombus, thereby making the distance between each antenna be as long as possible.

Since the GPS antenna 510 is only used for receiving the GPS signal without transmitting, reception of wireless communication signals at the other antennas is not interfered with by the signals at the GPS antenna 510. Thus, it is only necessary to consider interference to signal reception at the GPS antenna due to the WLAN signal, the WPAN signal, and the WWAN signal. In practice, for decreasing interference to the GPS band, the WWAN antenna 530 is configured at a distance from the GPS antenna 510 of at least λ_{GPS}/2 (or odd integer multiples of λ_{GPS}/2), and the WLAN antenna 550 is configured at a distance from the GPS antenna 510 of at least λ_{GPS}/2 (or odd integer multiples of λ_{GPS}/2); the WPAN antenna 570 is also configured at a distance from the GPS antenna 510 of at least λ_{GPS}/2 (or odd integer multiples of λ_{GPS}/2). In addition, since the WLAN signal and the WPAN signal are received/transmitted at 2.4 GHz band, the distance between the WLAN antenna 550 and the WPAN antenna 570, the distance between the WLAN antenna 550 and the WWAN antenna 530, and the distance between the WWAN antenna 530 and the WPAN antenna 570 are respectively arranged to be at least the distance of λ_{2.4G}/2 (or odd integer multiples of λ_{2.4G}/2), to decrease incurred interference to the 2.4 GHz band. In another embodiment, a band-pass filter with high rejection to the WWAN band is further employed in the WLAN module 560 and/or the WPAN module 580. The band-pass filter can be utilized to filter out radiated noise at the WWAN band in a transmitting signal, so as to reduce interference to the WWAN signal due to the WLAN signal and/or the WPAN signal thereby avoiding affecting the sensitivity of the WWAN antenna 530.

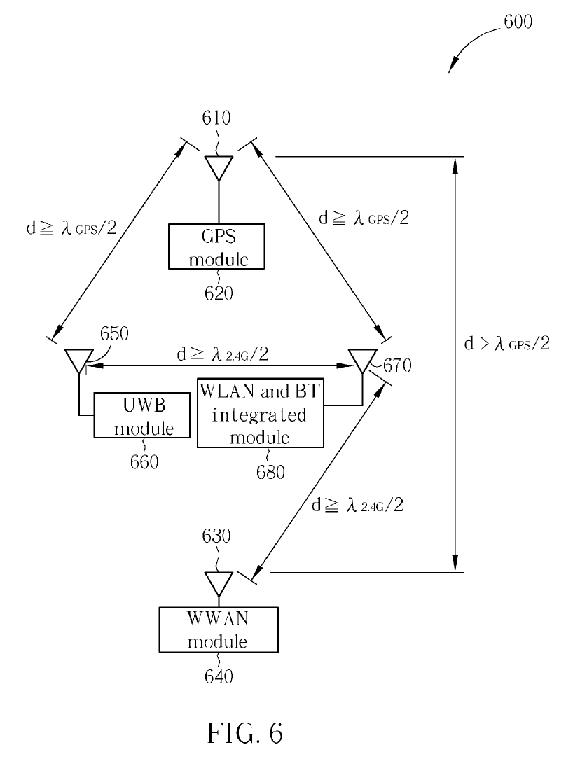

Please note that the embodiment shown in FIG. 5 is only used for illustrative purposes and is not meant to be a limitation of the present invention. That is, the present invention is not limited to be only applied to an application integrating functions of the GPS, WLAN, WPAN, and the WWAN systems. For example, the WPAN module 580 shown in FIG. 5 can be replaced by a Bluetooth (BT) module or an integrated WLAN and BT module, wherein the integrated WLAN and BT module receives/transmits the WLAN signal and the BT signal using the antenna 570. In addition, the WPAN module 580 or the WLAN module 560 can be replaced by a Zigbee module which receives/transmits signals at the 2.4 GHz band as well; Zigbee signals are received and transmitted by the antenna 570 or antenna 550. The WPAN module 580 or the WLAN module 560 can be replaced by a UWB module, as shown in FIG. 6; the antenna 650 of FIG. 6 is utilized to receive and transmit a UWB signal. In the embodiment of FIG. 6, the band 3.1 GHz-10.6 GHz employed by the UWB module 660 is far higher than those employed by the GPS module 620, the integrated WLAN and BT module 680, and the WWAN module 640, so the interference to signal reception of the UWB module 660 due to signals of the other modules is slight. Moreover, the transmission power employed by the UWB module 660 is much smaller than that employed by the WWAN module 640, so the interference to the WWAN module 640 is also slight. Therefore, it is required to appropriately arrange the distance between the antenna 650 employed by the UWB module 660 and the antenna 610 and to design the distance between the antennas 650 and 610, to reduce the interference to the GPS signal and WLAN signal due to the UWB signal. The distance between the UWB antenna 650 and WWAN antenna 630 can be elastically arranged, depending upon the system requirement or user's requirement.

The above embodiments are preferred embodiments of the present invention. The above embodiments disclose various multi-antenna modules including three to four antennas respectively, however, the number of the antennas or processing circuits and the types of the wireless communication modules are not intended to be limitations of the present invention. Those skilled in the art will readily observe that numerous modifications and alterations of the multi-antenna modules may be made while retaining the teachings of the invention. Accordingly, the above disclosure should be construed as limited only by the metes and bounds of the appended claims.

Through planning the distance between each antenna and disposal of the specific antenna, the above-described multi-antenna modules 100, 400, 500, and 600 can achieve an objective of better signal isolation, and can be applied to integrate functions of various wireless communication systems. Compared to the conventional scheme, the characteristic of the antennas employed by the multi-antenna modules 100, 400, 500, and 600 are not limited to include specific limitations, so these antennas can be directly implemented by ready-made antennas. The antennas can be those produced under different process conditions. Furthermore, the multi-antenna modules provided by the embodiments of the present invention are not limited to planar assembly devices, so not only can they be flexibly applied to other applications but the speed for product development can also be increased due to fewer limitations in the product development process.

Those skilled in the art will readily observe that numerous modifications and alterations of the device and method may be made while retaining the teachings of the invention.

What is claimed is:

1. A multi-antenna module, comprising:
a first antenna, for receiving or transmitting a first wireless signal;
a second antenna, for receiving or transmitting a second wireless signal; and
a third antenna, for receiving or transmitting a third wireless signal;
wherein the first wireless signal comprises at least one of a satellite signal, a wireless metropolitan area network (WMAN) signal, a wireless wide area network (WWAN) signal, a wireless personal area network (WPAN) signal, and a wireless local area network (WLAN) signal; the second and third wireless signals comprise at least one of a WMAN signal, a WWAN signal, a WPAN signal, a WLAN signal, and an ultra wide band (UWB) signal; a position of the first antenna is disposed higher than positions of other antennas in the multi-antenna module when the first wireless signal comprises a satellite signal; the second antenna is disposed on one side of the multi-antenna module when the second wireless signal comprises a WPAN signal or a WLAN signal; and a position of the third antenna is disposed lower than positions of other antennas in the multi-antenna module when the third wireless signal comprises a WMAN signal or a WWAN signal.

2. The multi-antenna module of claim 1, wherein the first antenna is away from the second antenna at a distance of half a wavelength of the first wireless signal at least.

3. The multi-antenna module of claim 2, wherein the distance between the first antenna and the second antenna is odd integer multiples of half the wavelength of the first wireless signal.

4. The multi-antenna module of claim 1, wherein the first antenna is at a distance from the third antenna of at least half a wavelength of the first wireless signal, and the second antenna is at a distance from the third antenna of at least half a wavelength of the second wireless signal.

5. The multi-antenna module of claim 4, wherein the distance between the first antenna and the third antenna is odd integer multiples of half the wavelength of first wireless signal, and the distance between the second antenna and the third antenna is odd integer multiples of half the wavelength of the second wireless signal.

6. The multi-antenna module of claim 1, wherein the satellite signal comprises a global positioning system (GPS) signal or a satellite radio signal.

7. The multi-antenna module of claim 1, wherein the WMAN signal comprises a Worldwide Interoperability for Microwave Access (WiMAX) signal.

8. The multi-antenna module of claim 1, wherein the WWAN signal comprises a Global System for Mobile communication (GSM) signal, a third-generation mobile system (3G) signal, a Wideband Code Division Multiple Access (WCDMA) signal, a General Packet Radio Service (GPRS) signal, or an Enhanced Data rates for GSM Evolution (EDGE) signal.

9. The multi-antenna module of claim 1, wherein the WPAN signal comprises a Bluetooth (BT) signal, a Zigbee signal, or a radio-frequency identification (RFID) signal.

10. The multi-antenna module of claim 1, wherein the WLAN signal comprises a WiFi signal.

11. The multi-antenna module of claim 1, further comprising:
a fourth antenna, for receiving or transmitting a fourth wireless signal;
wherein the fourth wireless signal comprises at least one of a WMAN signal, a WWAN signal, a WPAN signal, a WLAN signal, and a UWB signal; the position of the first antenna is disposed higher than other antennas in the multi-antenna module when the first wireless signal comprises a satellite signal; the second and third antennas are respectively disposed on different sides of the multi-antenna module when the second and third wireless signals respectively comprise a WPAN signal and a WLAN signal or respectively comprise a WLAN signal and a WPAN signal; and a position of the fourth antenna is disposed lower than positions of other antennas in the multi-antenna module when the fourth wireless signal comprises a WMAN signal or a WWAN signal.

12. The multi-antenna module of claim 11, wherein the first antenna is at a distance from the fourth antenna of at least half a wavelength of the first wireless signal; the second antenna is at a distance from the fourth antenna of at least half a wavelength of the second wireless signal; and the third antenna is at a distance from the fourth antenna of at least half a wavelength of the third wireless signal.

13. The multi-antenna module of claim 12, wherein the distance between the first antenna and the fourth antenna is odd integer multiples of half the wavelength of the first wireless signal; the distance between the second antenna and the fourth antenna is odd integer multiples of half the wavelength of the second wireless signal; and the distance between the third antenna and the fourth antenna is odd integer multiples of half the wavelength of the third wireless signal.

14. The multi-antenna module of claim 1 is configured in an embedded system.
